(19) United States
(12) Patent Application Publication
(10) Pub. No.: US 2013/0013650 A1
(43) Pub. Date: Jan. 10, 2013

(54) VISUAL AND CONTEXT-ORIENTED CURATION PLATFORM

(76) Inventor: Annie Shum, Hopkinton, MA (US)

(21) Appl. No.: 13/544,534

(22) Filed: Jul. 9, 2012

Related U.S. Application Data
(60) Provisional application No. 61/505,857, filed on Jul. 8, 2011.

(51) Int. Cl. G06F 17/30

(52) U.S. Cl. 707/805; 707/E17.045

(57) ABSTRACT

Information is organized according to context to manage large amounts of data with a useful result. Schema definitions and other structure-defining components can be defined by curators or individuals to organize information according to context, and permit presentation of the context in the form of a mapping. The map topology can also be defined by curators and individuals for forming a visual map of the context-oriented data. Such visual maps can embed applications that can use the context-oriented data as input to expand the usefulness of the context-organized data. A repository can store relationships between the contexts as established by the schema, as well as data and data structures related to linking applications or contexts in accordance with curation activity. The resulting visual map is searchable, filterable and browseable to permit useful data insights to be annunciated.

### CROSS REFERENCE TO RELATED APPLICATIONS

This application claims the benefit of U.S. Provisional Application No. 61/505,857, filed Jul. 8, 2011, the entire disclosure of which is hereby incorporated herein by reference.

### BACKGROUND OF THE INVENTION

The present disclosure relates generally to information searching and organization, and relates more particularly to organizing searchable content in a visual and context oriented format for promotion of insight in relation to the information.

With the ubiquitousness and ease of use of communication devices and communication networks, vast amounts of information have become widely available to individuals on a global scale. Numerous sources of information are readily accessible through present communication networks. Personal communication devices have become relatively inexpensive and easy to use, as well as being widely distributed. Users connected to communication networks can access vast amounts of information with relative ease using these personal communication devices. Personal communication devices may include items such as desktop computers, mobile phones, facsimile machines, distributed computing terminals, and any type of computational device with a user interface that can be connected to a communication network to send and/or receive information.

While access to communication networks and sources of information has become increasingly simplified and easier for individuals in general, being able to locate specific information within a relatively large information set has become challenging. For example, an individual connected to the Internet can browse a relatively large information set by directing a browser to any one of a vast number of uniform resource locators (URLs) that may provide information on a given topic. Some URLs may represent a collection of information that is searchable. Some well known examples of URLs or websites that collect information that can be searched include Wikipedia.org, Lexis-Nexis and other commercial and/or generally available sites that act as informational repositories that are available for search.

Aside from specific resources in a communication network that provide information collections, a network can act as a general information resource due to the large numbers of information sources connected to the network. Searching facilities for locating information in a network are also well known, including such search engines as Google.com, Bing.com and other URLs that provide a single resource access point for searching information available on a network.

In addition to information collections, network information resources and search engines, other types of resources, sometimes referred to as “portals” are available to help organize or locate information that is available on a relatively large scale, where a user may have a specific focus on particular topics. Some examples include Yahoo.com and MSN.com and other sources that provide the user with some type of information management tools to permit the user to obtain topic specific information, which may be updated on an ongoing basis. Some examples of tools that are offered by a typical portal may include stock market quotes, news related to a particular industry, general news, updates on a particular area of technology and other topics of interest to the user. Typically, these tools permit the user to select from a relatively small set of available options for managing information, with the set of options often being determined by popular usage. For example, broad categories of sports, general news, financial news or other areas of interest that may appeal to a relatively broad constituency may be presented for selection by a user of the portal.

The above-mentioned information access and management tools are confronted with significant challenges with respect to the nature of the information that is being accessed or managed. For example, the sheer abundance of information available through information resources and communication network connectivity represents a significant challenge in locating information that is significant to a given user. Users conducting research and attempting to bring together and correlate different pieces of information may therefore have a significant challenge in sorting through information to determine relevancy. The concept of searching based on key words can be helpful in reducing the quantity of information which may then be determined to be pertinent to a user's research. However, it is often difficult to determine whether appropriate key words have been used to obtain desired pertinent information. In addition, search engines typically attempt to list information resources in terms of the most relevant as determined by the search engine algorithm and the key words used in the search. Due to the uncertainties with respect to the applicability of the search engine criteria and key words used in the search, a user may not be made aware of pertinent information in relation to the searched topic.

Advertising is another area of online activity that faces significant challenges with regard to providing relevant data to a given user. Currently, advertising placement and targeting is generally heuristic at best, typically being based on a determination made at a single level and generic target keywords. Other ad targeting techniques are known that use personal historical data that may be collected via cookies. This approach tends to be viewed as highly intrusive and undesirable from a number of perspectives such as sustainability and legality. For example, the collection of typically massive amounts of personal historical information via cookies or browsing/shopping patterns tends to incur high overhead costs in terms of both physical and monetary resources. This approach also tends to create a large footprint with respect to user resources and risks issues of invasion of privacy.

Sometimes data is collected and manipulated for a particular purpose, such as in the case of database applications. Such useful collections of data are often intended for a given user or group of users, and such application solutions tend to be topic specific and relatively inflexible. For example, such solutions are often implemented in the form of a software application that may collect, analyze and/or present data in a way that is useful for a given user or group of users. Such software applications tend to be specifically written for a given purpose for such users and tend to be difficult to modify or update with regard to new paradigms or new information sources, for example.

### BRIEF SUMMARY OF THE INVENTION

According to the present disclosure, a visual and context driven learning/knowledge discovery system is provided for managing information. The information can be curated by knowledgeable individuals, and can be presented through individually personalized architectures. The present disclosure provides a system and method for visually accessing and managing a knowledge repository with curated categorization and interconnectivity that can be tailored to a given group or to individual desires based on, for example, information context. Individuals can organize and configure information collections based on desired contexts and subject matter, for example, and review the information collections using graphical or visualization tools and techniques to contribute to more intuitive information access.

Organized data in accordance with the present disclosure can be updated and augmented based on automated search criteria and curation activities, for example. Curation activities may include expert input for forming additional interconnections between information collections or contexts to assist in adapting or expanding a users context or subject matter for a given topic of interest.

According to one aspect, the information can be collected and organized in accordance with a schema that provides a user selectable architecture and structure for organizing information context and access. In general, the organization of data in terms of interconnections and contexts can be based on metadata relationships that define how different categories of data may be interrelated. Curators, who may be experts in a given field or in cross disciplinary knowledge can provide the schema and metadata relationships, including assigning items such as tags, pointers, and other identification data to create metadata and further establish metadata relationships. A repository for the organized data stores the metadata and metadata relationships in accordance with the schema and assigned metadata. Curators can update the schema, metadata and metadata relationships to add, modify and delete related context and interconnections between data and/or information resources to provide users with a stable and highly useful visual platform for accessing desired information.

According to an aspect of the present disclosure, users can add content and context and further personalize the context-driven interconnected visual map architecture of the present disclosure as desired. For example, in accordance with this aspect of the present disclosure, a user can be provided with tools to modify the presentation of visual information, as well as tools to modify the contexts and interconnections presented in the visual map. The tools permit the user to modify metadata and metadata relationships to establish a customized set of contexts and connections between related categories of interest. In addition, tools can be provided that permit a user to customize the visual map in a visual sense to reflect a users preference for presentation of context and connection oriented information of interest. In accordance with the present disclosure, a user can quickly and intuitively obtain detailed context oriented information that may be related to a number of different disciplines or information sources to be able to obtain both a large-scale picture of a given topic, as well as potentially small details that may be related to other information sources and/or disciplines.

According to a feature of the present disclosure, various topic contexts can be associated with revenue generating activities, such as, for example, advertising. A user context that contains sufficient detail in accordance with the context-driven visual map architecture of the present disclosure may have various paid-for information associated with the context or details. The advertising can be directed more specifically to a target audience by using the contextual and detail-level approach provided by the present disclosure. Accordingly, advertising targeting can be more directly focused on interested individuals or groups than is possible with other types of targeted advertising.

According to another aspect of the present disclosure, paid-for information or advertising can be provided with respect to a broader targeted audience or more specifically defined targeted audience. For example, certain types of advertisements can be provided to a context representing a relatively high level in a hierarchy of contexts, which context may appeal to a number of different groups or individuals in general. More specifically targeted paid-for information or advertising can be provided to users or groups associated with lower level contexts or sub-contexts in a contextual hierarchy, to more effectively present specified advertising to a more interested audience. Payment for such advertising or information distributed in accordance with a general or specific configuration can be scaled in accordance with the context to which the advertising or information is directed. For example, advertising or information directed to a broader audience may be less expensive than similar advertising or information directed to a more specific audience, as determined by the context or sub-context in a contextual hierarchy in accordance with the present disclosure.

In addition, the targeted advertising need not be revenue generating, but can also be related to information sharing, such as by providing collaborative opportunities for researchers or decision-makers, for example. Where a given contextual-driven collection of information draws together interested parties, the potential for soliciting collaborative activities or information can be enhanced and more relevant.

According to a feature of the present disclosure, facilities are provided for content to be inserted and/or updated at a given context or level within a visual map. The content can be associated with metadata and/or metadata relationships that help to define the content and the context in which the content may be placed or accessed. The content can be provided in a number of forms, such as hyperlinks, annotated text, blogs, published documents, and any other kind of content or information that may be referenced with a network connected device. The content may be provided on a cost basis and owned/administered by a given provider. The content may be updated automatically, as may be achieved with the use of a search engine.

The content associated with various contexts or levels of the visual map can be analyzed for a number of useful points of information. For example, authorization for access to information or to update or insert information in the visual map can be centrally maintained or distributed among the various portions of the visual map. Security for the information associated with the content or context of the visual map can be analyzed to identify patterns or obstacles for information access, as well as availability. Analysis can also be conducted to provide quality control for the information content and for the context and contextual relationships to ensure operability and a certain level of quality of service.

Analysis of the constructs, contexts, relationships and content of the visual map can also produce statistical results that can be useful in a number of areas. For example, a context can be identified as being particularly popular for obtaining certain types of content. The statistical knowledge can thus be used to indicate that further context separation or sub-contexts are desirable, for example. Statistically significant uses of the visual map can also be helpful in targeting strategies for placement of advertising. For example, the analysis can track access patterns and routes, e.g., how a user got to the particular content in the contextual structure of the visual map. Specific feedback can also be obtained for the information content or for the contextual structure of the visual map to improve usefulness on a targeted basis.

According to an aspect of the present disclosure, context specific applications are provided in association with a given node or sub-node of a visual map. One or more applications associated with a given node of a visual map can harness information organized within the context of the node, and/or sub-nodes of the visual map to provide aggregated, condensed and/or correlated information associated with the given context. For example, an application can aggregate and analyze specific information determined by the context of the node, as determined by curators or individuals, to produce results related to the information that are useful for general or specific purposes. Applications and their output can be made available to particular groups or entities, including individuals, and can be tailored with respect to the desired output of each of those constituencies. The applications can use the defined metadata and metadata relationships in a repository to be adaptive or dynamic in nature. For example, the applications can take advantage of modifications made to a context by curators or individual users to modify the data input to the application to thereby produce new results for output. Such applications can also use other like enabled applications to augment functionality.

### BRIEF DESCRIPTION OF THE SEVERAL VIEWS OF THE DRAWINGS

The disclosure is described in greater detail below with reference to the accompanying drawings, in which:

FIG. 1 is a menu of items of topical interest;

FIG. 2 is a diagram describing implementation of a visual map in accordance with an exemplary embodiment of the present disclosure;

FIGS. 3-5 are diagrams of visual maps in accordance with an exemplary embodiment of the present disclosure;

FIG. 6 is a diagram describing usage cases for a visual map in accordance with the present disclosure;

FIG. 7 is a diagram of a visual map with an example of a context value chain in accordance with the present disclosure

FIG. 8 is a diagram illustrating conceptual processes for implementing an exemplary embodiment of the present disclosure;

FIG. 9 is a diagram illustrating priority of components for implementing an exemplary embodiment of the present disclosure;

FIG. 10 is a diagram illustrating process flow according to an exemplary embodiment of the present disclosure;

FIG. 11 is a flowchart illustrating curation activity for a visual map in accordance with an exemplary embodiment of the present disclosure; and

FIG. 12 is a flowchart illustrating application update operations in accordance with an exemplary embodiment of the present disclosure.

### DETAILED DESCRIPTION OF THE INVENTION

This application claims the benefit of U.S. Provisional Application No. 61/505,857, filed Jul. 8, 2011, the entire disclosure of which is hereby incorporated herein by reference.

The present disclosure relates to a visual and context-driven curation platform/ecosystem in which users can consume (buy), provide (sell) and implement or receive precise online ad placement. The information organization of the present disclosure permits targeting of fine-grained context-driven curated (quality) knowledge/insight in the form of personalizable interactive (tactile) visual interconnected maps, pre-populated and residing in a persistent and live knowledge/insight repository, hosted, for example, in a wide-scale network of interconnected devices, sometimes referred to as a cloud or cloud computing.

According to an exemplary embodiment of the present disclosure, applications can be provided to permit a more particularly focused information organization and presentation. For example, an application can harness particular context oriented information structure and content to derive useful results that can be presented to end users. Specially enabled applications can be aware of other like applications and utilize their functionality and dynamic nature to provide dynamic results.

One of the main concepts of the present disclosure is the idea of “context before content.” In implementing the visual and context oriented information presentation, the ultimate information content matters less than the organization of the content, so that contexts of information is considered first. In this way, substantial amounts of information and content can be managed in a realistically useful way. The contexts used to organize and manage information and content reflect categorization/classification schemas as well as connections/links related to the relevant subject of interest, along with perspectives of the author of the schema. As used herein, the term “schema” refers to an abstract collection of metadata, consisting of a set of schema components, such as element and attribute declarations and complex and simple type definitions. These schema components are usually created by processing a collection of documents that contain the source language definitions of these schema components.

In one sense, the present disclosure seeks to decouple contexts from content, where the foundation of each visual map is the context topology. Context topology refers to the organization of contexts used to manage related information, both from a subject matter categorization as well as a visual connection and presentation. Curators formulate the contexts (and sub-contexts) and the interrelationships among them. Vectors of information can be populated into a data and relationship repository for each value chain of context and sub-contexts, as described below. Each vector can be tagged and attached to more than one context and sub-context value chain. Users can navigate, explore and search the context topology by following the context value chains. Curators can add/modify/delete the various portions of the visual maps, including the contexts, sub-contexts, nodes, vectors and connotations within which a give data item might be referenced. Curators can reshape the context topology by manipulating the context value chain via a state-of-the-art UI (including conventional “drag-and-drop” mechanisms as well as modern tablet enabled multi-touch tactile gestures). The context topology of a visual map can change in an entirety or within a portion as a context value chain is re-arranged and reconnected to reflect new insight or bespoke personalization of perspectives.

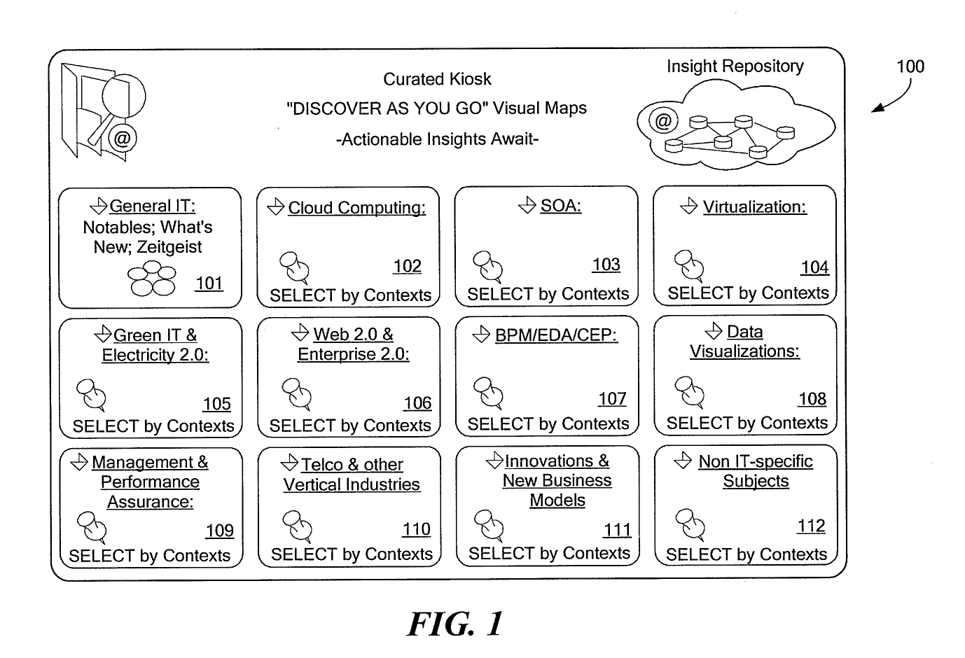

Referring now to FIG. 1, an exemplary diagram of a top level of visual map topics 100 is illustrated. Topics 100 can be provided as a display in a user interface, such as may be provided through a personal computer, tablet, kiosk or any other type of user interface that can provide a display to a user. Topics 100 are displayed as a gateway or menu for topics that are organized in accordance with the present disclosure. Each of items 101-112 can be individually selected to choose a topic about which further information is desired. Each of items 101-112 may also be collectively organized into a higher level topic category, such as, for example, “information technology,” since items 101-112 can all be placed within the context of information technology with regard to aspects of the described subject matter. Each of items 101-112 may also be interrelated by context and/or connections through each individual visual map associated with items 101-112. Accordingly, selecting one of items 101-112 may also reveal connections between other items or sub-context of other items and their various connections.

One or more of items 101-112 may also be implemented as an application that may use input related to one or more topic categories of topics 100. For example, items 101-112 may be related by some type of context, or may have sub-context that are related, any of which can be used in an application that may be associated with one or more topics. For example, an application may be associated with item 102, in relation to cloud computing, that analyzes current cloud computing platforms for a specific criteria, such as resource availability or through-put capability. An application can be associated with each one of items 101-112, or associated in general with topics 100, or made available on the basis of being related to a sub-context of one or more of items 101-112. The use of such an application tends to contribute to aggregating, organizing and/or presenting data in a useful way for a targeted user or a group of users.

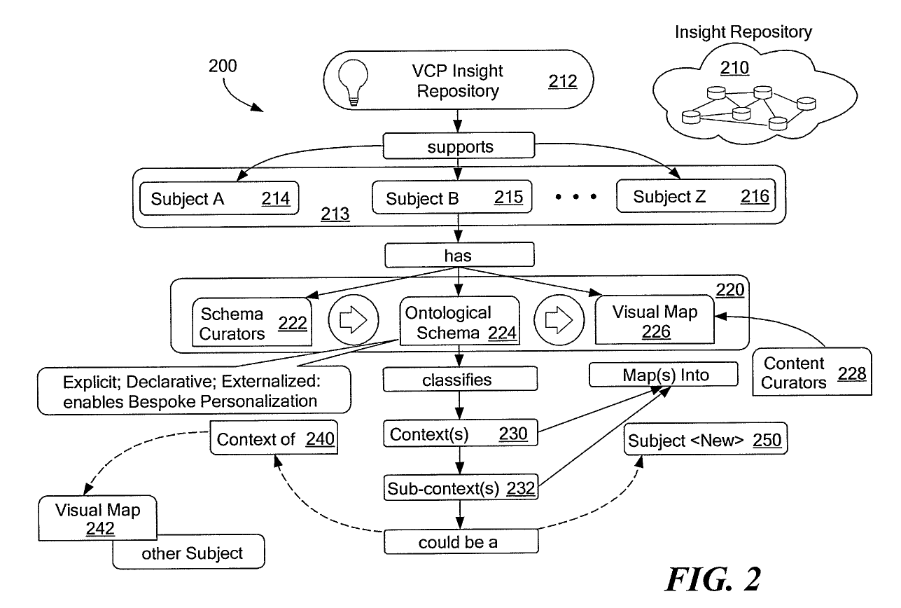

Referring now to FIG. 2, a diagrammatic overview of an exemplary embodiment of the present disclosure is illustrated. Overview 200 illustrates an architecture for accessing and/or manipulating a repository of data through visual maps and organized structure, such as particular context and connections provided among different content topics. A repository 210 represents a data store that can exist on a number of different platforms, from individual, stand-alone devices, to individual or groups of devices connected through a network, to large scale public networks that interconnect numerous devices that may act as information sources. Accordingly, repository 210 may act as a single information resource, or a collection of information resources, which in either case may be implemented on a single device or numerous interconnected devices.

Repository 210 can be thought of as a “living” repository, in that it can be constantly and regularly updated with information, contexts and connections that modify visual maps related to the information content stored in repository 210. Repository 210 also stores metadata and metadata relationships for providing information about context and interconnection among various topics, categories, context, interconnections, and any other type of representations of information and information access. An exemplary implementation of the metadata and metadata relationships stored in repository 210 is the construct of a relational database that includes tables organized according to a given topic, category, context or conceptual relationship. Relationships between information stored in different tables are also provided in such an exemplary construct, such as by providing indexes, keys and other types of tools or constructs that indicate relationships among data stored in different tables.

The metadata and metadata relationships stored in repository 210 are not to be limited to the construct of a relational database, but may be so implemented in accordance with an exemplary embodiment. The metadata and metadata relationships provide a generalized structure for supporting one or more visual maps in terms of how the context, connections, conceptual relationships and information content is visually presented to the user. The metadata and metadata relationships define relationships between contexts and context related content within a visual map. For example, the metadata and metadata relationships may define how a user views information within a given context, and the connections to other contexts and informational content. The metadata and metadata relationships may be used to implement a visual link between two contexts, between a context and a sub-context, or between any of these and information content. In addition, the metadata and metadata relationships define a hierarchy of contextual information, connections and conceptual relationships within a visual map to contribute to defining the user's experience and interaction with the information content.

Conceptual access to repository 210 is illustrated with block 212, which may be implemented as a point of access on a network, such as the internet, a VPN, WAN, LAN or a single device that may host a data repository. Overview 200 illustrates access to repository 210 through subject matter indicated with blocks 214-216 at a level 213. Each of the topics of blocks 214-216, indicated as subject A, subject B through Z, is organized according to some type of context or category to provide a first level hierarchy for selection by the user.

Each of subjects A-Z represented by blocks 214-216 can be associated with one or more applications that may utilize or present data related to specific ones of subjects A-Z. The applications may use context-oriented information organized under subjects A-Z and/or additional or external information as input that can be analyzed or manipulated to produce a useful result for a user or a group of users. Such applications can have access to repository 210 to take advantage of the metadata and metadata relationships to obtain input data that may contribute to producing useful results for the end-users.

The topics of subjects A-Z in blocks 214-216 can be very generalized, or can be provided as subtopics in a broader category. For example, the topics shown in items 101-112 of FIG. 1 may reside at level 213 illustrated for subjects A-Z of blocks 214-216, or may be provided in a lower level subcategory related to information technology. For example, subject A of block 214 may relate to information technology, which might be selected to produce a display such as that illustrated in FIG. 1.

The various topics illustrated in blocks 214-216 may be curated by individuals or groups of persons that have different perspectives, knowledge or organizational goals related to the information content. As illustrated with a level 220, curators 222 may provide schema 224 for organizing a visual map 226 directed to a particular topic of interest, in this case, subject B illustrated in block 215.

Schema curators 222 may individually or as a group provide or modify ontological schema 224 to contribute to organizing the topic of subject B in block 215 according to particular contexts and connections. The ontological schema provided in schema 224 is used to create a visual map 226 that provides a visually oriented presentation of information related to subject B, in accordance with schema 224. Schema 224 can provide definitions for metadata and metadata relationships that are stored in repository 210. Alternately, or in addition, schema 224 can provide a framework for organizing metadata and metadata relationships. Curators 222 may be individual users of the systems and methods of the present disclosure, or individuals that are permitted to personalize the presentation of information in accordance with a customized schema to form desired contexts and connections for visual map 226. Accordingly, visual map 226 may be customized on a personal level to suit the needs of the individual. Visual map 226 may also be provided based on the needs or desires of a group or collections of individuals or groups, in which case curators 222 may be responsible to the group or collection of individuals or groups with regard to maintaining contextual and connection configurations for visual map 226.

Curators 222 provide ontological resources for organizing the information that is somehow connected with the chosen topic, in this case subject B illustrated in block 215 of level 213. Curators 222 as an ontological resource provide a representation of knowledge or information as a set of concepts within a context and the relationships between those concepts. By grouping concepts related to the subject matter in accordance with a given context and connection or relationship between concepts, curator 222 can model the information in a way that promotes intuitive insight into the information, similar to how assimilation of information may occur in relation to human experience. Accordingly, curators 222 engage in taxonomy with regard to a particular context and information topic to help classify content and connections between concepts and content in accordance with a given context. The taxonomy is formalized by schema 224, which can provide explicit, declarative and externalized structure for organizing the information related to the topic of interest. It is schema 224 that, once established, drives the organization of visual map 226 as used by a given constituency. Schema 224 may be organized in an ontological sense in that it provides management tools for storing relationships, interconnections, metadata, tags, and other organizationally related structure to permit information to be automatically arranged according to a schema definition.

Prior to formation or population of visual map 226, curators 222 may help to formulate a context and schema concept for the information of interest. According to an exemplary embodiment, the exercise of formulating ontological categorization schema and conceptualizing a context and abstract organization of visual map 226 may be thought of as being similar to formulating schema related to database architecture, which typically involves categorizing related information into sets, and defining the relationships between the sets of data. Thus, the conceptualized context of the information of interest can provide a network of multidimensional relationships and properties that may fall within and/or outside of the subject matter of interest. The conceptualization strategy need not be implemented as a formal or classic ontology, but can be intended to provide an explicit specification of conceptualization. This broad assessment of conceptualization of the information of interest lends itself to a more open model of contextual assignment and configuration of connections between context and concepts.

As the schema for a particular subject is formulated, a categorization process undertaken by curators 222 implements a mapping for each context of the topic of interest as a node in visual map 226. A context node has links and branches to other contexts, sub-contexts and/or content information, which each may in turn have links and branches to additional contexts, sub-contexts and/or content information. Visual map 226 may have a hierarchy of contexts and sub-contexts in accordance with a dedicated schema 224, which contexts or sub-contexts may be assigned as higher or lower level context or sub-context nodes in other visual maps or other subject matter related by connections provided by curators 222. For example, the sub-context nodes of a given visual map may be identified as separate formal subjects that implement dedicated ontological schemas and context, sub-context and connections.

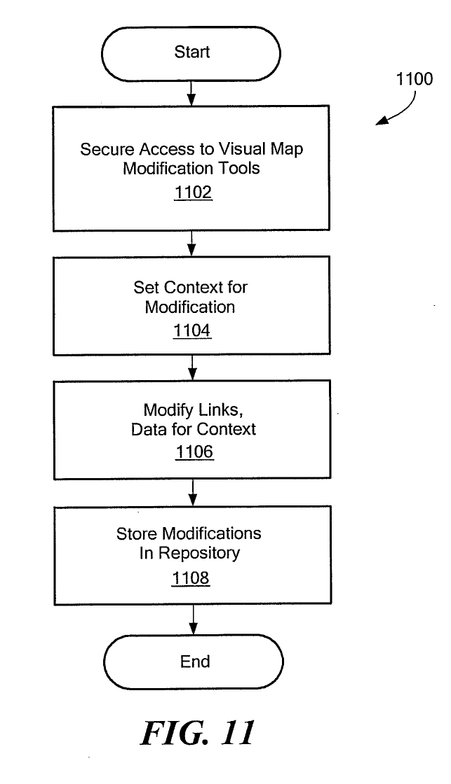

Referring for a moment to FIG. 11, a flowchart 1100 depicts operations related to updates to a given visual map in accordance with the present disclosure. In accordance with the exemplary embodiment illustrated in flowchart 1100, a curator gains access to a visual map and visual map modification tools through secure access, as shown in block 1102. A curator may, for example, be required to enter a login ID and/or password, or provide other authentication credentials to access the visual map of interest, as well as the visual map modification tools.

Once admitted to the system for modification of a visual map, the curator may set a desired context for modification, as depicted in block 1104. The curator can set a context using the visual map modification tools, which can permit browsing, searching or filtering of visual nodes to obtain the context of interest for curation activity.

With the context set as desired, the curator may modify parameters associated with the context, including metadata and metadata relationships, such as by adding, modifying or deleting links related to the selected context, as is depicted in block 1106. The curator may cause an application to be embedded in a given context or visual node, such that users that access the context or visual node can execute the application. The changes to the context are stored in repository 210, for example, as shown in block 1108. In the course of curating the selected context, the curator may modify or delete context relationships, visual map topology, content and applications in accordance with a desired curation goal. A curator may also modify the schema related to the context or visual map to cause the structure of the context and visual map to be modified.

In overview 200, context 230 and sub-context 232 are classified through schema 224 under subject B illustrated in block 215. Context 230 and sub-context 232 are mapped to visual map 226 in accordance with schema 224 to provide visual map nodes that can be displayed in an intuitive presentation for accessing and discovering information and connections between topics and contexts. Accordingly, conceptual relationships and connections can be established between, for example, sub-context 232 and context 240, which has a dedicated visual map 242. Similarly, sub-context 232 may define conceptual relationships and connections with another topic 250 that may be of interest with respect to the present topic of subject B illustrated in block 215. Once the mapping of contexts to nodes in visual map 226 is completed, visual map 226 and context 230 and sub-context 232 can be populated with information in accordance with schema 224, metadata and/or metadata relationships, as may be defined in repository 210.

The contexts 230 and sub-contexts 232, as well as the organization and definition of nodes in visual map 226 can be curated on a ongoing basis through several techniques. For example, curators 222 may modify schema 224 or definitions of context 230, sub-context 232 or mappings for nodes in visual map 226. Content curators 228 may also manipulate visual map 226 directly, by arranging nodes or information context and/or connections according to a desired configuration. Content curators 228 may be individuals seeking customized information access or knowledge discovery, or groups or collections of individuals or groups seeking to organize information in accordance with some desired goal, context or understanding.

The above described ontology-style schema works well with constituencies that are relatively stable and are finite in number as well as being domain specific. Curators 222 or 228 acting as authorities for ontological classification can formulate effective navigation mechanisms with significant value to users in developing insight and knowledge for a particular subject. The use of expert authorities as trusted curators, as well as permissive individualized customization for ontological classification schemas can help to improve both inclusion and filtering of information, context and relationships for a desired goal or set of concepts, such as developing actionable insights or assimilating or discovering information and conceptual relationships, such as in the case of students of a given topic. Thus, expert guidance coupled with the flexibility, scalability and empowerment of individual users produces a powerful combination for managing information and understanding otherwise hidden obscured or unknown context and relationships for understanding of a given subject or related subject matter.

According to an exemplary embodiment of the present disclosure, schema 224 may be encoded in human-readable format based on open standards, such as by implementing schema 224 using XML. Schema 224 can be explicit, declarative and externalized to improve the potential for participation by varied constituencies, leading to significant potential benefits and opportunities for acting on information.

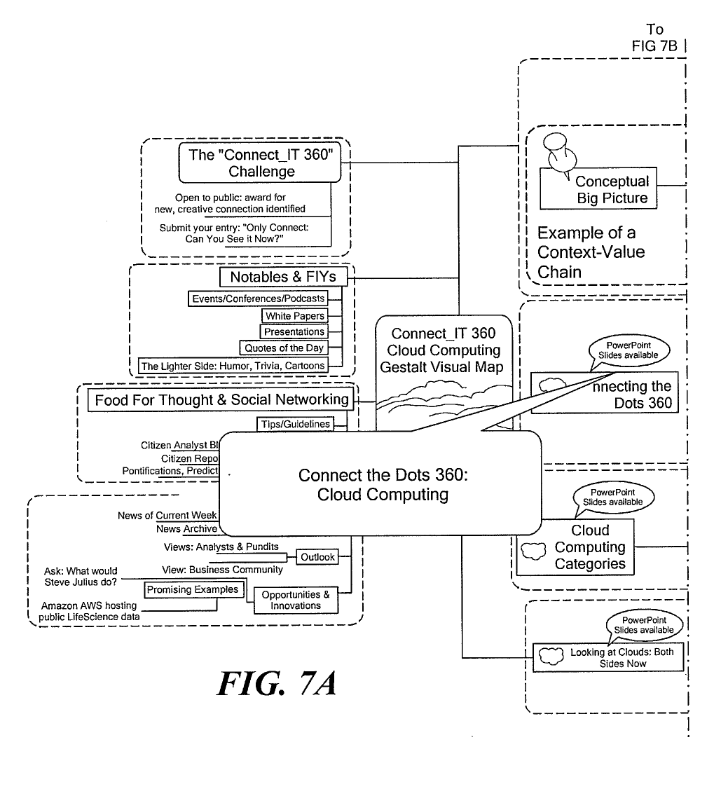

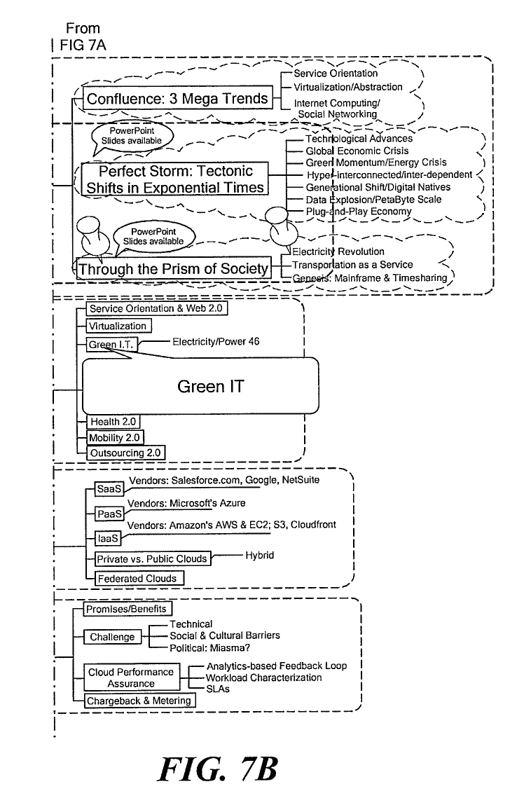

The foundation of each visual map 226 is the context topology. Curators 222 formulate the contexts (and sub-contexts) and the interrelationships among them. The navigation path consisting of a context and its chain of sub-contexts. The chain of a context and its sub-contexts is described herein as a context value chain, as is illustrated in FIG. 7. Each context value chain can be uniquely identified and tagged with an appropriate identifier to maintain the uniqueness of the context value chain. The context value chain illustrated in FIG. 7 is composed of: a subject: Cloud Computing; a context: Conceptual Big Picture; a sub-context: Through the Prism of Society; and a sub-sub-context: Electricity Revolution.

Curators 222, also acting as taxonomy curators, create the context value chains using well known tools, such as through a visual GUI that enables easy creation, modification and manipulation of visual map 226, which can also operate as a topology map. Alternatively, or in addition, curators 222 can opt to create a topology schema, e.g., a layout for visual map 226, using a text-based interface that automatically translates text into topology nodes and context value chains. The topology schema itself can be rendered visually as visual map 226, reflecting the topology of context value chains.

In addition, the topology schema can be externalized textually. One exemplary form of this representation is the above-mentioned XML format. Such a format permits visual presentation of content in different ways based different sets of relationships established for the content, as memorialized in, for example, one or more XML files. The metadata associated with various constructs in a visual map, such as nodes, contexts, vectors (described below), sub-contexts, connections and conceptual relationships, may be used to identify those constructs in an XML file, for example. The XML file also memorializes metadata relationships in this exemplary embodiment, so that a visual map can be created from XML statements and constructs. Different XML files may be used to produce different visual maps based on the same content, for example.

According to an exemplary embodiment, a GUI is used to create and map the various constructs of a visual map, such as by locating a given construct in a hierarchy (by drag and drop, for example), or drawing a line between different constructs to create a link. The visual components of the so created visual map are memorialized as metadata and metadata relationships in an XML format, for example. The metadata and metadata relationships are stored in the repository in a condensed format that can be used to represent XML code while occupying less memory. For example, the metadata and metadata relationships may be stored in hash tables and accessed using standard XML tools such as XSLT, XQuery or XPath. In this way, visual map nodes and vectors associated with the visual map nodes can be populated into repository 210 for each value chain of context and sub-contexts. The same visual map node and/or vector can be tagged and attached to more than one context and sub-context value chain. In addition, the metadata is searchable by curators or users to help establish a visual map design or to locate specific contexts or content, for example.

Users can navigate, explore and search the context topology or visual map by following the context value chains. Curators 222 can add/modify/delete the visual map nodes and vectors. Curators 222 can reshape the context topology by manipulating the context value chain via a state-of-the-art UI (including conventional desktop “drag-and-drop” mechanisms as well as modern tablet enabled multi-touch tactile gestures). The context topology of a visual map can change as an entirety or a portion of a context value chain is re-arranged and reconnected, potentially to other visual maps, context value chains or visual map context nodes, to reflect new insight or bespoke personalization of perspectives.

While curators 222 and users interact with the visual front end services, the present disclosure also provide a set of machine-based backend services to support the context topology creation, modification and management. In particular, the backend services provide a full range of advanced and robust metadata related (functional) services pertaining to the context interconnectivity topology mapping. The provision of these services contributes to ensuring that repository 210 as a backend object is not only a living and persistent structure (as opposed to the volatile nature of traditional Web pages), but that it can be personalized to accommodate end users' perspectives and points of view, in that it is easy to use and scalable. Each visual map node or vector is tagged with metadata. Some metadata may provide a unique identity for the context value chain wherein the visual node or vector resides. A visual node or vector can reside in multiple context value chains. Accordingly, the associated metadata can include the unique identity of the context value chain to permit the visual node or vector to be uniquely identified by, for example, a search, while being locatable via a number of paths represented by multiple context value chains.

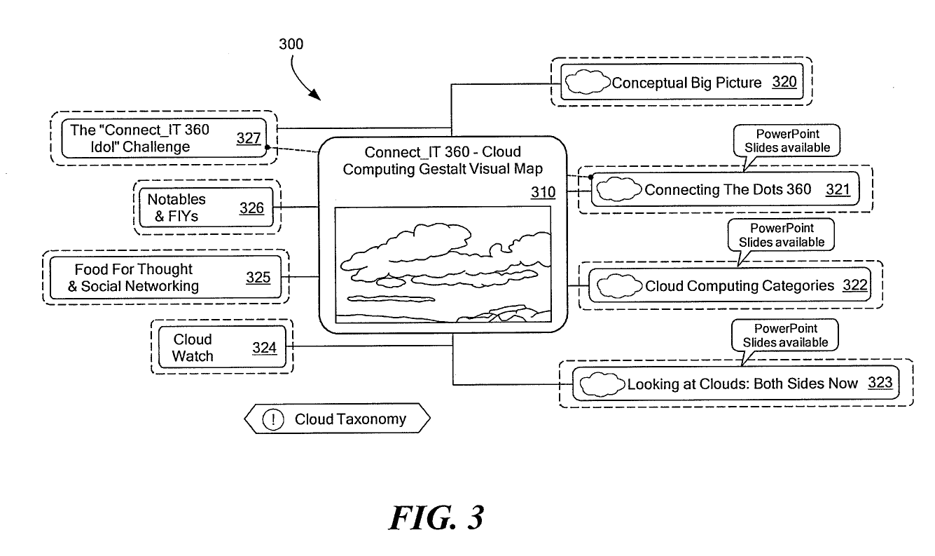

Referring now to FIG. 3, a visual map 300 illustrates some of the key concepts of the present disclosure. Visual map 300 illustrates a specific organization of contexts related to a subject 310, in this case cloud computing. Visual map 300 includes visual nodes 320-327, each of which pertain to contexts in which cloud computing bear some relationship for subject matter content. Visual nodes 320-327 are formulated by one or more curators by mapping a schema oriented context to each of visual nodes 320-327 in connection with subject matter or concepts specifically related to each visual mode. Visual node 320-327 provide “zoomable” visual perspectives on information related to the subject 310, with various levels of detail and reference available for overview and/or fine grained context, interconnections and/or content.

The curators may utilize various techniques of data mapping and modeling to formulate the organization of visual nodes 320-327 and may modify or expand the schema, contexts or relationships embodied in visual map 300 on an ongoing basis. The data mapping and modeling that may be used by curators may be similar to that used for database architecture to define conceptual groupings and/or relationships. For example, standard multidimensional relationships often used in organizing relational databases may be defined for visual nodes 320-327, or for the contexts, interconnections or relationships defined for each visual node. Multidimensional relationships may include one-to-one, one to many, many to many or many to one, as is well known in the field of relational database construction and management.

Users of visual map 300 can explore a given topic according to various aspects or perspectives using visual nodes 320-327 and predefined contexts, interconnections, relationships and concepts for the underlying content. The use of visual map 304 for knowledge discovery now supports freeform exploration and assimilation of information in a “discover as you go” type of format, which can promote an increase understanding and application of information related to a given topic. Because the information accessible through visual map 300 can be constantly or regularly updated, either through interaction with a curator or automatically in conjunction with ontological schema and taxonomy, users can obtain salient and meaningful understanding of new information in relation to the defined contexts, interconnections, relationships and concepts defined through visual map 300.

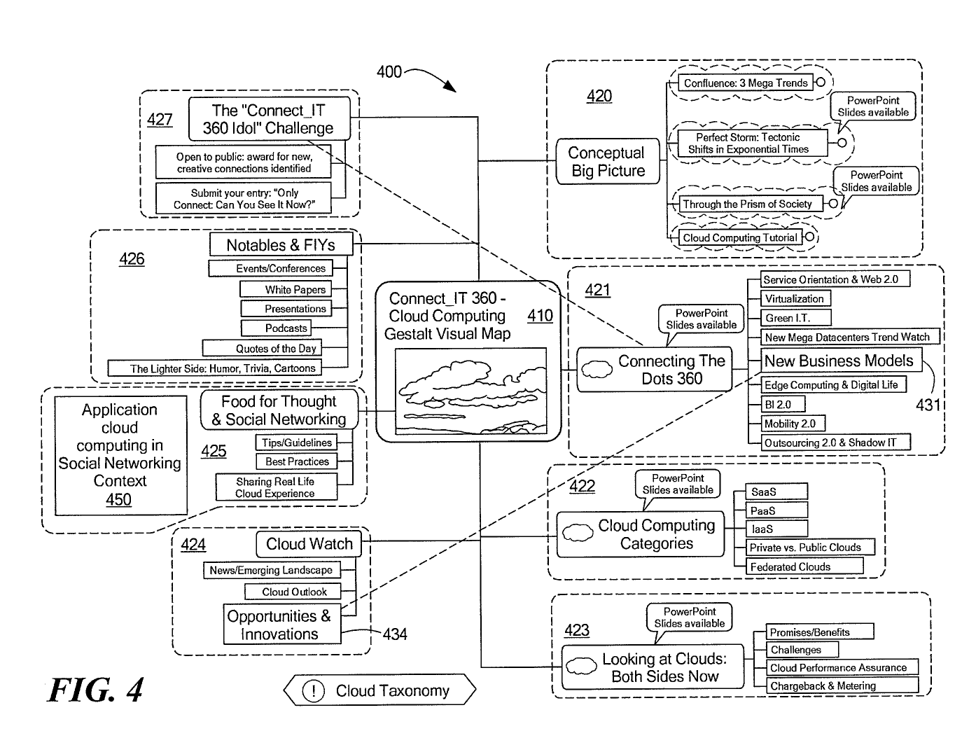

Referring now to FIG. 4, a visual map 400 is illustrated, which represents an expanded view of visual map 300 (FIG. 3). Visual map 400 includes expanded visual nodes 420-427, which may be expanded versions of visual nodes 320-327 illustrated in FIG. 3. Visual map 400 illustrates how connections between various contexts may be observed or established, as well as additional features that maybe provided in accordance with the present disclosure. For example, visual nodes 421 and 427 may be related by being contexts of subject 410, in this case cloud computing, as well as by sharing some subject matter context or conceptual relationship. Visual node 427 indicates the opportunity for identifying new contexts or sub-contexts, and potential relationship with other contexts and sub-contexts. Visual node 421 can provide various technical details related to cloud computing, so that interconnections between visual nodes 421 and 427 may be naturally made, and may be used to establish new sub context or sub nodes if desired. Visual node 424 may provide information related to developments in cloud computing, including a sub-context 434 related to opportunities and innovations. Sub-context 434 may relate to a sub-context 431 of visual node 421, which provides access to information related to new business models. The relationship between sub-contexts 431 and 434 may be used to establish a new relationship in a schema defining the organization of visual map 400, or a new sub-context devoted to common concepts of sub-contexts 431 and 434, as well as potentially introducing additional concepts related to that new sub-context. In each case of modification of visual map 400, visual nodes 420-427, sub-contexts, relationships or concepts, a schema associated with visual map 400 can be updated to provide a mechanism for providing persistent methods for access to the updated portions of visual map 400. As part of the update to visual map 400, newly created portions, such as visual nodes, sub-contexts, connections or conceptual relationships can be provided with automatic mechanisms for refreshing or adding to content in the architectural structure defined by the schema associated with visual map 400.

Visual map 400 may also provide access to applications that may be associated with one or more of visual nodes 420-427 or subject 410. Such applications may take advantage of the context structure, connections or conceptual relationships provided by visual map 400, including a related schema and/or information stored in an associated repository to produce useful results for users of the applications. For example, an application 450 may be associated with visual node 425 to provide a user with aggregated information related to social networking as it is involved with or applied to cloud computing. Application 450 may be exposed for access or when visual map 400 is accessed or expanded to show the various sub-contexts and sub-nodes. Application 450 may draw information from the context value chain associated with visual node 425, or the available context, connections or conceptual relationships associated with visual node 425. An output of such an application may provide the user with statistics on cloud computing implementations for social networking, for example, including graphical representations or links to new research relating the concepts of social networking and cloud computing. A user of such an application can immediately locate new information of interest in relation to the topics of social networking and cloud computing and be presented with information that may lead to innovations or implementations involving the two concepts.

Applications in accordance with the present disclosure can be stand alone software programs that have some specified data as input and provide a particular output that is useful to a user or group of users of visual map 400. The applications can be associated with a given visual map or visual node, or a particular context or sub-context or content. In general, applications can be used to aggregate, condense and correlate data, and provide or synthesize a useful result for an intended user or group of users.

Visual maps, such as visual map 400, can be based on a backend or support service that is a semantically enabled data (and meta-data) repository platform, such as repository 210 (FIG. 2) that may include a set of distributed services deployed in a public or private set of interconnected networks, sometimes referred to as cloud computing or cloud services. For example, public cloud services can be used, such as Amazon's EC2 or a hybrid set of services that is a mixture of public cloud services and private cloud services.

Visual map 400 can include context-oriented visual nodes, such as visual nodes 420-427, that represent a specific context or sub-context for classification (categorization) purposes. In accordance with an exemplary embodiment or the present disclosure, some visual nodes, such as visual node 425, for example, can be formed as “super” nodes by embedding an application in a context (or sub-context) node of visual map 400. Application 450 is exemplarily illustrated as being embedded and associated with visual node 425 to provide application 450 with context and relevance in regard to the subject matter of visual node 425. Application 450 can be potentially moved to other visual nodes, or associated with more than one visual map, context or visual node, and can be subject to curation activities based on changing contexts or visual maps.

While visual map 400 can offer a visual medium for curating, interconnecting and exploring knowledge/insight in general, application 450 embedded in or otherwise associated with a context or visual node 425 can significantly extend and/or augment visual map 400. For example, application 450 can support computing and execute functional tasks such as by providing realtime or just-in-time analytics. Implementations of applications associated with or embedded in a visual node can range from that providing simplistic functionality to those providing highly complex and advanced features, and can be provided on a stand-alone basis, e.g., not necessarily associated with a particular visual map, context or visual node.

Application 450, like visual map 400, can be a relatively “thick” client or rich internet application (RIA) running on a client of a client-server configuration. The client can be implemented on any type of network capable device, including such items as mobile phones, PCs or other internet aware devices, including touch-screen enabled tablet device such as iPads or other tablets. Visual map 400 can be implemented using robust commercial RIA platform tools such as Microsoft's Silverlight, or can be deployed as a conventional thin client in the form of standard HTML Web pages. The use of an RIA type client permits visual map 400 to support rich, highly interactive, engaging end user interactions and contextual navigation. In addition, should the network connection between the client and service side be disrupted or disconnected, an RIA type client can continue to execute while being offline.

According to an exemplary embodiment, a context or visual node 425 becomes a “super” node when it is associated with or embeds a URL for execution of application 450. Application 450 can be integrated with visual map 400, and thus be dependent on the context and content of visual map 400 and/or visual node 425, for example. Alternately, or in addition, application 450 can be a stand-alone application that can be independent of visual map 400. Thus, an end user can interact with visual node 425 as a “launch pad” for application 450. Application 450 can include a front end and a backend architected and deployed like visual map 400. For example, a visual user interface front end for application 450 can reside on the client side, such as by being a next level drill down of super node 425. The backend can be a set of cloud services deployed either in a public cloud such as Amazon or in a hybrid Cloud—a mixture of public and private cloud services.

According to an exemplary embodiment, an end user can interact with a super node using the user interface to cause the node to fluidly expand and enlarge while the other context nodes can shrink correspondingly in size. This viewing paradigm contributes to maintaining contexts or visual nodes of interest in the display while accommodating an expanded view of the super node and/or application such that the user can focus on particular contexts or applications without losing connectivity with surrounding or linked contexts or visual nodes. This viewing paradigm has been described above as a “fish-eye” technique. Alternatively, or in addition, an entire big picture view of the visual map can be reduced to a minimal viewing size and docked in a designated area such as by anchoring the minimized visual map to a side or corner of the display. In any case, the application can receive a larger viewing field suitable for easier viewing or interaction with the user.

According to an exemplary embodiment, a visual map-associated application supports GPS location awareness to permit the application to respond to realtime events. The application can also, for example, integrate with near field communication (NFC) technology to permit communication over very short distances using radio frequency carriers. This technology allows the implementation of such activities as tap pad transactions that may include identification and/or value exchanges such as monetary payments or charges.

In accordance with an exemplary embodiment, a relevant context and/or visual node can be provided with an embedded application that accepts inputs of an individual's vital signs and provides personal analytics asynchronously. For example, a visual map might be provided related to “Personal Healthcare” and include an associated or embedded application related to “Personal Analytics.” Such a personal healthcare visual map with associated/embedded applications can provide personal analytics and monitoring on an ongoing basis, such as 24 hours a day, seven days a week.

According to an exemplary embodiment, a personal analytics application associated with a visual map performs a number of operations. For example, the application can conduct data mining operations that may include data modeling, meta-data formulation, data analysis/synthesizing/normalizing/summarizing, data input from a variety of sources such as end user input, blood tests, wireless sensors, mobile tracking/monitoring devices, Microsoft's Health Vault and other data mining or input functions. The application can create interactive, multi-level, multi-dimensional visualizations of personal health metrics, such as graphs or charts, that present readily observed data patterns, such as trends or threshold crossings. The application can create automatic anomaly detection and conduct impact analysis of the personal health metrics obtained by data mining or data presentation. The application may also provide a reactive response or alert and adapt to realtime events, such as pollen count or the spread of a contagious disease as may be the case with an outbreak of influenza.

The application can also provide summary results and accumulate and maintain data over time to establish historical summaries, trends and baselines for personal analytics. Aided by NFC technology, the application can respond to local conditions such as allergy pollen count and alert end users who have hay fever or notify the user of a 5K run in the neighborhood. The potential opportunities for innovation and provision of context-oriented applications are many. For example, because visual maps reside in the cloud, an advanced feature is to aggregate data not just for an individual but all users to study population patterns and shifts. Or applications can uncover patterns for specific demographics when the aggregated data is filtered through the lens of the social graphs clustering.

Beyond data aggregation, an application associated with or embedded in a visual node can correlate to other contexts in a visual map in near realtime based on predefined rules and/or self (machine)-learning. Machine learning refers to programming that permits a machine to recognize patterns and modify operations based on such pattern recognition. Examples of such programming include neural networks and applied statistical analysis. As an example, if the data in the case a personal health metric exceeds certain threshold such as when the total cholesterol level is between 200-239 mg/DL, in addition to triggering an alert warning, the application can recommend that the user review/study another context node on “the tutorial of cholesterol level” or on “diabetes.” If the cholesterol level is above 240 mg/DL, the embedded app can also notify your primary doctor, for example. The application may recognize new contexts based on knowledge of or a link associated with a known node. The application may also be increased in functionality through links to other like applications that are context or visual map schema-aware, as discussed in greater detail below.

Visual nodes 421-423 of visual map 400 also include features for accessing presentations related to the contextual subject matter of those visual nodes. A user can access those presentations through visual map 400, or through visual map 300 shown in FIG. 3, as the presentations are associated with the higher-level context of visual nodes 421-423, or visual nodes 321-323 shown in FIG. 3.

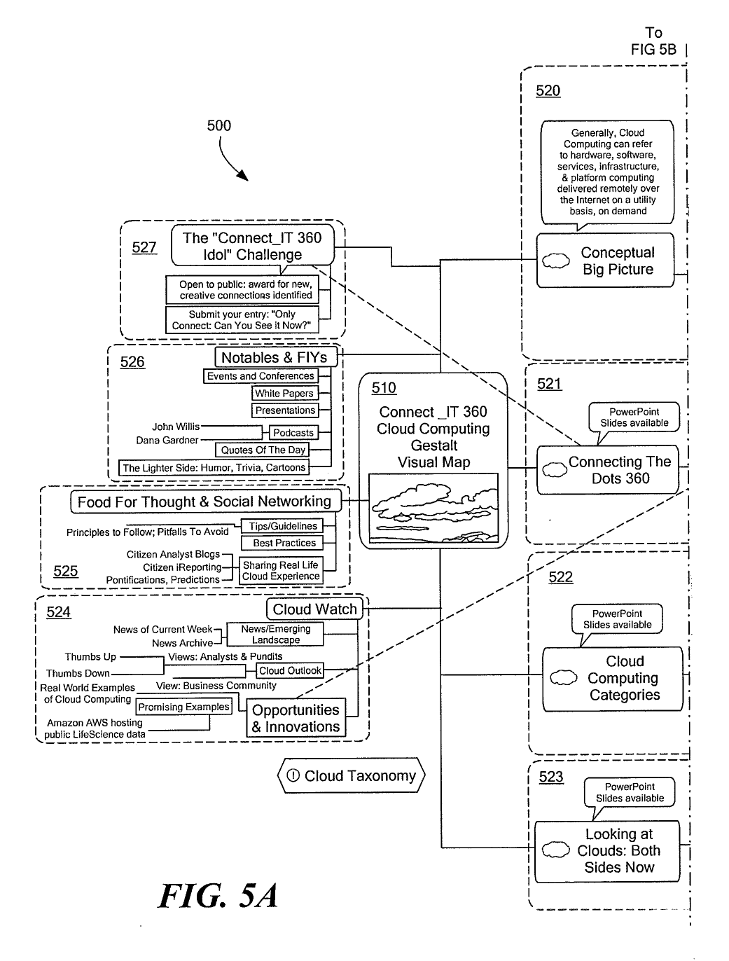

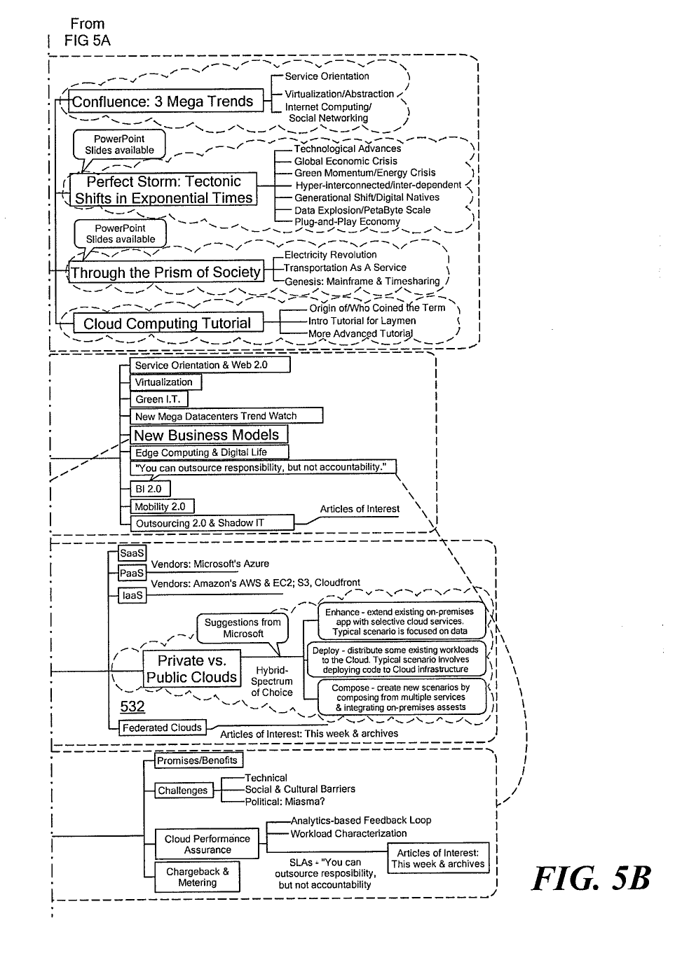

Referring now to FIG. 5, a visual map 500 is illustrated as an expanded view of visual map 400. Visual nodes 520-527 may be visually expanded individually or as a group to show additional detail related to a sub-context level or particularly chosen context or conceptual relationship. For example, visual map 500 shows a relationship between visual node 523 and visual node 521 with respect to commentary on cloud computing and technical aspects of cloud computing. While FIG. 5 illustrates expansion of contexts related to cloud computing by expanding contexts and sub-contexts organized under visual nodes 520-527 related to cloud computing, other visual arrangements and configurations are readily available. For example, a user may select a visual node, which then becomes a major view in the display presented to the user. Other topics, contexts and/or sub-contexts that bear some relationship with the selected visual node, context or sub-context can be presented in the display, permitting the user to visually asses, access and potentially make additional intuitive or associative connections between potentially disparate content. For example, while the items shown in visual map 500 all bear some relationship to each other or topic 510 related to cloud computing, other topics or whole categories of subject matter may be presented in the display for access by the user based on criteria defined in schema that may be individually personalized or set by an expert curator. The visual map of the present disclosure therefore is able to take advantage of increased understanding of expert curators as well as individuals for updating and improving the visual map mechanism for increased potential knowledge, assimilation or information discovery among different constituencies of individuals, groups or collections of individuals or groups.

FIG. 5 illustrates one of the features of the present disclosure in which a high granularity of detail is provided according to a chosen context for a given topic, while maintaining an overall “big picture” view of the topic of interest. According to an exemplary embodiment of the present disclosure, the high granularity of detail provided by visual map 500 is used to provide a simplified and highly targeted advertising facility for various constituencies, which may include business customers, vendors, collaborators, researchers, individuals, and any targeted audience to which paid-for advertising or information may be directed. For example, a user particularly interested in the context of visual node 522, such as cloud computing categories, can have paid-for advertising or information directed to them that relates generally to cloud computing categories.

If, for example, the user further expresses an interest in the sub-context of private versus public clouds, such as by selecting sub-context 532 related to private versus public clouds, more specifically targeted paid-for advertising or information may be directed to the user that relates particularly to aspects of private versus public cloud computing. In this way, advertising can be more easily targeted and directed to an interested user and a highly relevant audience. Advertisers or entities seeking to provide paid-for information can thus be provided with various options and scales of targeting as well as more specific related costs. For example, a merchant may be charged a lower rate for a more general advertising campaign directed to a more general, higher level subject context, and may be charged a higher rate for more targeted advertising that can be directed to a more specific interest at a lower level subject context in a context hierarchy of a visual map. The merchant is thus able to conduct a campaign on several levels of interest and targeted opportunities to obtain more productive and rewarding results.

Ads may be implemented in a number of different ways, which may depend on subject matter or context of a visual map or a context value chain. As may be configured to be presented once a user selects a particular node in a visual map, such that there is a high degree of relevancy between the advertisement and the context of the selected node of the visual map. As a user selects various sub-nodes or sub-contexts, more specific advertising can be presented to the user, as an alternative to, or an addition to the advertisement associated with a higher level context and node of the visual map. Other types of advertising targeted techniques can be used to compliment the specific advertising available with the context hierarchy of the visual map. For example, a user may implement a search in a context value chain or in association with a given context of a visual node, which search may include keywords that can be used to present specific targeted advertising in relation to the searched words. A user may have access to various filters to limit the visual nodes or context provided by the visual map, which filters can be used to provide additional specificity to presented advertising. Each of the above-noted scenarios can be selected for different and specific advertising by an advertising entity, or paid for information resource.

Interest in the paid-for advertisements or information may be gauged or analyzed to provide feedback to the merchants or groups paying for the advertisements or information provision. This arrangement for targeted advertising provides much greater accuracy in reaching a relevant demographic, since the user has expressed in a specific interest in a given topic within a specified context.

This approach also avoids the drawbacks of known targeted advertising campaigns that tend to rely on single level determinations, such as a URL or key word, or otherwise rely on potentially intrusive tracking techniques to determine consumer preferences or purchase patterns. Known online ad placement is generally driven by heuristic algorithms based on targeted, and often generic, key words. Such implementations have an inherent weakness because it is a fairly macro approach and ad placements are typically determined based on a single level of information as discussed above. Attempts to improve relevance and/or accuracy are generally based on extensively tracking (typically via cookies) of the historical and detailed information of the user's browsing/access/purchase patterns. This type of tracking can be viewed as intrusive and users may find such techniques repelling. Extensive tracking of a user's activities tends to be neither cost effective nor scalable. In addition, such extensive tracking risks invading personal privacy and at times, possibly violating privacy laws. Accordingly, the approach taken with the present disclosure avoids the high overhead, risk of invasion of privacy and lack of accuracy in ad placement.

The collection of masses of personal historical data need not take place in accordance with the approach of the present disclosure, while precision, accuracy and detailed targeting is improved by utilizing the explicit, implicit and inherent knowledge provided by the content topology and context value chains of the present disclosure. Thus, the present disclosure provides an advertising placement technique that is relevant, scalable and cost effective by leveraging the multi-tiered contexts and sub-contexts of the visual maps to identify and hone in on very specific and precisely targeted ad placements. This approach reduces or eliminates guesswork on the intent or interest of a user in accessing a given visual map, context, sub-context, filter, search result, connection, link or content, for example. Once the taxonomy curators formulate the schema of a given visual map, the topology schema can then be distributed to merchants for them to select target contexts/sub-contexts to realize very precise ad placements. Vendors can also offer ads that provide relevant value-add content without guesswork. Meanwhile, analytic tools and mechanisms can provide valuable and up-to-date feedback for the merchants to track the effectiveness of the ad placements.

The advantages realized in such systems and methods according to the present disclosure are manifold. Merchants can realize unprecedented accuracy to support matching merchant ads to consumer needs at each (sub)context level and thereby substantially lower ad noise and increase consumer click rates. Both merchants and consumers benefit in that vendors realize accurate ad placement without guesswork and can effectively provide optional but relevant value-add content directly to an interested consumer. The approach of the present disclosure engenders development of a new breed of online ad placement software with simplified algorithms that avoid collection of masses of personal historical data and reduce or eliminate guesswork. Such software can leverage the multi-tiered contexts and sub-contexts of visual maps using the taxonomy schema that defines and directly provides all the fine-grained contexts and sub-contexts for precise online ads placement. The software may also substantially lower ad noise and increase consumer click rates while being cost-effective with a small footprint and being non-intrusive. In addition, the algorithms embodying the concepts of the present disclosure enable a new breed of multi-tiered performance-based pricing strategy. The more detailed the sub-context level, the more precise the target ads can be. Merchants can pay more for the significantly higher accuracy, sans guesswork, of the online ad placement. For example, the more detailed sub-context levels will cost more for ads.

Another advantage of this approach is that ads may become generally less intrusive to the user while being cost effective and efficient in producing results. It is possible that merchants or groups seeking to target a specific context and topic for paid-for advertising and/or information may be willing to pay more for the greater accuracy and increased efficiency in relation to the targeted topic and context.

By providing a high level of granularity, such as is possible with visual map 500, the present disclosure can provide additional features that are less easily implemented in other, known systems. For example, information security can be provided on a number of different levels of visual map 500, as well as information access, which can be configured to be provided on a cost-basis model. As a user seeks greater detail on a topic within a given context, certain branches or leaves related to such detail may be provided by information resources at cost, which configuration can easily be maintained in accordance with the visual map architecture that provides specified hierarchies of contexts and sub-contexts.

The same architectural configuration of the visual map lends itself to analytic applications that may be used to help ensure performance related to particular subject matter and context in terms of availability, responsiveness, consistency and quality of service, for example. The frequency with which certain contexts, sub-contexts, connections, relational concepts, branches or leaves are accessed can be analyzed to indicate volume of usage and a popularity or relevance scale. This type of information can be easily obtained in accordance with the visual map architecture to improve service, generate new contexts, sub-contexts, connections or conceptual relationships, as well as providing specific and relevant feedback for merchants or groups interested in paid-for advertising or information.

Visual maps such as visual map 500 may be accessed according to different modes of usage. In accordance with an exemplary embodiment of the present disclosure, a visual map may be accessed in read mode, which permits the user to navigate and explore a collection of visual maps in a free-form navigation mode. The contexts available to the user can be searched or filtered on a semantic basis to expedite navigation and permit free-form discovery. The search and/or filter mechanisms may be implemented with items such as tags, meta-data, taxonomy, domain expertise, and other techniques that permit rapid identification of items relevant to the user's interest. The user can select various discovered contexts and associated visual maps or visual nodes to dynamically explore a topic and related contexts, connections and conceptual relationships. The user can also zoom or drill into a selected context for more detailed information without losing a global or higher-level focus or context. For example, visual map 500 fluidly adjusts to the selection of a visual node and/or context or sub-context to highlight and expand the selection while reducing or moving to the periphery other less related visual nodes or contexts. In this way, the user in read mode can access detailed information for a particular topic in a given context, while continuing to be made aware of the larger scope of subject matter of interest. This “fisheye” style of zooming or drilling into a visual map is helpful in visually accessing and understanding information context and conceptual relationships, since the visual map architecture is intended to maintain multiple connections at multiple levels with regard to associated contexts and content. For example, this approach greatly improves the visual accessibility of managed information as compared to conventional vertical-oriented system that do not easily permit an understanding of contextual relationships among various information topics.

Read mode also permits continued searching and filtering to identify desired detail and contexts within which the detailed information is located. The results of searching and filtering at one or more levels of a visual map may produce the contextual, connection and conceptual relationship organization, as well as detail level information that may exist at a leaf of a visual map structure. Detail level items can be content-oriented and may include documents, annotations, articles, commentary, vectors of information collected from various disparate sources, white papers, reports and any other type of detail level information that can be marshaled within the meaning of a context and/or conceptual relationship.

Other aspects of read mode may include providing feedback on the quality or content of a visual map and its associated contexts and sub-contexts. Read mode is also suitable for accessing collections of visual maps in conjunction with social networking sites, including such popular sites as Twitter, Facebook and LinkedIn. Visual maps are also provisioned with tools and mechanisms to permit the user to print various aspects of the visual map or detail level information while in read mode.

Users may also access visual maps in an update mode, which permits contribution of contextualized information, context and sub-context definitions, schema additions or modifications, as well as conceptual relationships and content and applications in accordance with the present disclosure. In update mode, a distinction may be made between private and public usage, in which updates might be made in accordance with a cost scale. For example, a public user may be permitted to update certain types of public information or access certain applications in update mode or contribute information in specified contexts or sub-contexts. Other users may be configured to have access to private collections of visual maps or applications that may be updated with private or public information and selectively shared or not shared in accordance with the private user's desires. For example, the private user may be permitted to grant or restrict access to private information or applications with regard to individual users or public use, which facility, in update mode, may represent a value added cost to the private user.

With regard to updates, additions or modifications to the content of a visual map may be permitted with respect to topics, contexts, sub-contexts, conceptual relationships, connections, content and/or applications. Additions or modifications to a visual map may be provided in the form of a vector of information that impacts a topic, context, sub-context, connection, conceptual relationship or application execution, for example. Each vector may include metadata such as a topic with which the vector is associated, application identifiers or associations, an immediate context and/or sub-context, date/time of contribution, source, contributors name, curator type, i.e., commissioned expert curator versus freelance curator, and access mode, for example, unrestricted versus restricted.

The vector can be associated with a number of different forms or formats, such as a text document, a PDF file, articles, URL links, publications, blogs, executable software programs or packages and any other type of information unit that can be identified using the vector configuration. A given vector may constitute a context or sub-context, connection or conceptual relationship, as well as information units discussed above. Vectors can be stored in repository 210 (FIG. 2) and can be retrieved and interpreted to form context-oriented structures and visual maps. According, visual nodes provided in a visual map can be implemented as vector units to which informational mapping may be applied in accordance with a schema and curator directed activities. A vector can be provided with a definition for various operational aspects, including secure access, paid advertising or information applicability, information aging, update acceptance, and any other type of criteria that may be used to manipulate the various portions of the visual map.

According to an exemplary embodiment of the present disclosure, each visual map with a defined contextual structure includes a common context that can be used to connect to other visual maps or portions of visual maps in a given repository. With reference to FIG. 5, visual node 521 links to a context for “connecting the dots 360,” which is provided at visual node 527 that can host connections to one or more other visual maps or applications in the repository for which visual map 500 is implemented. Each visual map in a given repository can be implemented to have a context in common with one or more other visual maps. The concept of providing a common context among the visual maps prevents any visual map from being isolated in the repository, so that barriers to knowledge discovery or information assimilation can be avoided. Thus, a cluster of interrelated technologies can be provided with interconnections and conceptual relationships among different aspects or perspectives of these technologies, which may involve multiple disparate disciplines, such as technological, social, political, business and/or economic disciplines. By providing a common context for all of the visual maps, obstacles and barriers that traditionally have existed across different disciplines can be broken down or avoided to significantly increase potential for cross-discipline innovation, understanding and/or collaboration. For example, visual node 521 provides a context that is common to at least one other topic in the repository to which visual map 500 belongs. The various sub-contexts of visual node 521 can be accessed to potentially direct the user to other high-level topics in the repository that bear some relationship to cloud computing topic 510. The configuration of the common contexts and their interrelationship with other topics, contexts, sub-contexts, connections or conceptual relationships is determined by a curator or groups of curators that have at least some cross-discipline understanding or knowledge to permit the common contexts to have meaningful value in terms of knowledge discovery and information assimilation.

The above discussed vectors or components of a visual map are typically created by trusted content curators that are domain experts in their respective fields. For each visual map, the vectors are prepared with thoughtful input from the designated content curators, which may include multiple curators responsible for overlapping contexts and assigned to each visual map to increase the coverage of the content provided within the visual map. The use of multiple curators with overlapping experience or knowledge can help to avoid biases or more than desired detail provided with respect to a given subject. The configuration of a visual map by trusted curators in accordance with the ontological schema provided to construct the visual maps can be reviewed by peers and/or other curators to obtain a degree of consistency and quality of service. Professional content curators and/or outside domain experts may be employed to conduct periodic reviews of visual map organization to help ensure visual map content quality and relevancy, among other parameters.

In addition, curators may receive feedback from users either directly or through analytic applications to understand the usefulness of the contextual architecture for a given visual map. Professional content curators may access a visual map in update mode and routinely provide services that may operate to filter, condense, synthesize, amalgamate, correlate and interconnect information in a given visual map. The professional content curators may be responsible for placing detailed information in an appropriate leaf of a given visual map accordance with the appropriate context and sub-context, for example. Professional content curators may also be responsible for editing or administering vector data or content provided by individuals. For example, the curator may move information provided by an individual to a more appropriate sub-context than that initially provided by the individual. The visual map is thus intentionally structured to permit growth and receive additional contextualized information that can be harnessed in accordance with the architecture of the visual map.

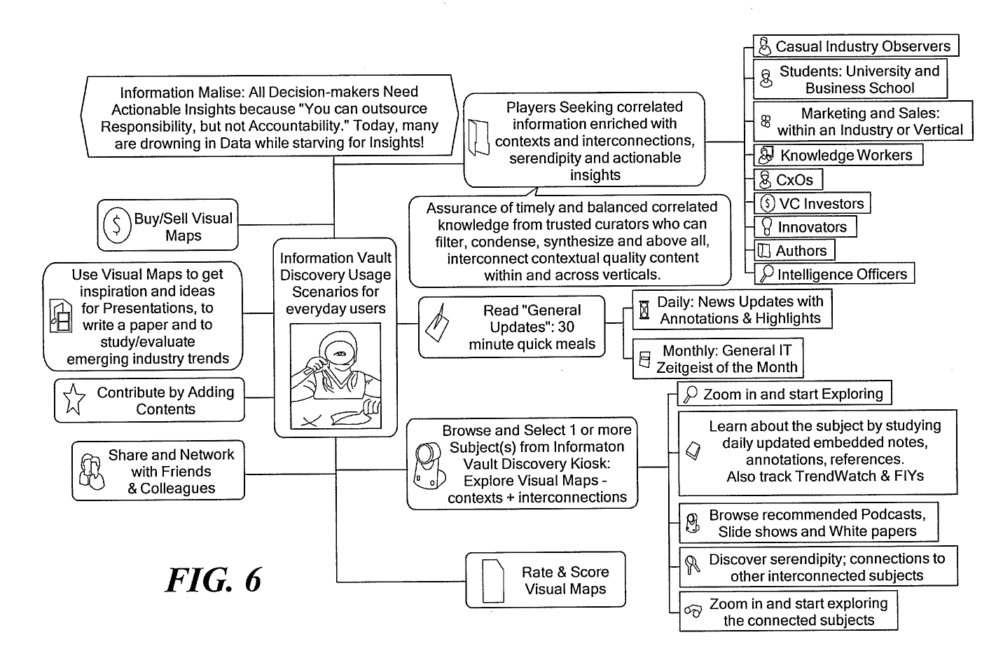

Referring now to FIG. 6, a usage case for implementation examples of the visual map are illustrated. For example, visual maps may be purchased or sold among particular groups with specific interests in obtaining insight into an information repository through the use of visual maps. Visual map interconnections provide an opportunity for collaborative research, which can be documented in a visual map through update mode to permit researchers to post information that can be shared in a collaborative setting in relation to a topic of interest. Opportunities for monetizing aspects of the visual map are also illustrated with regard to innovators, investors, information resources and teaching facility, for examples. The visual map can be updated based on some criteria, such as when a new publication or article becomes available, or on a periodic basis, for example. The visual navigation of the visual map significantly contributes to effective utilization of the information in an intuitive way that is a significant improvement over conventional systems that provide content based on keyword searches, encyclopedic structure or portal information selections.

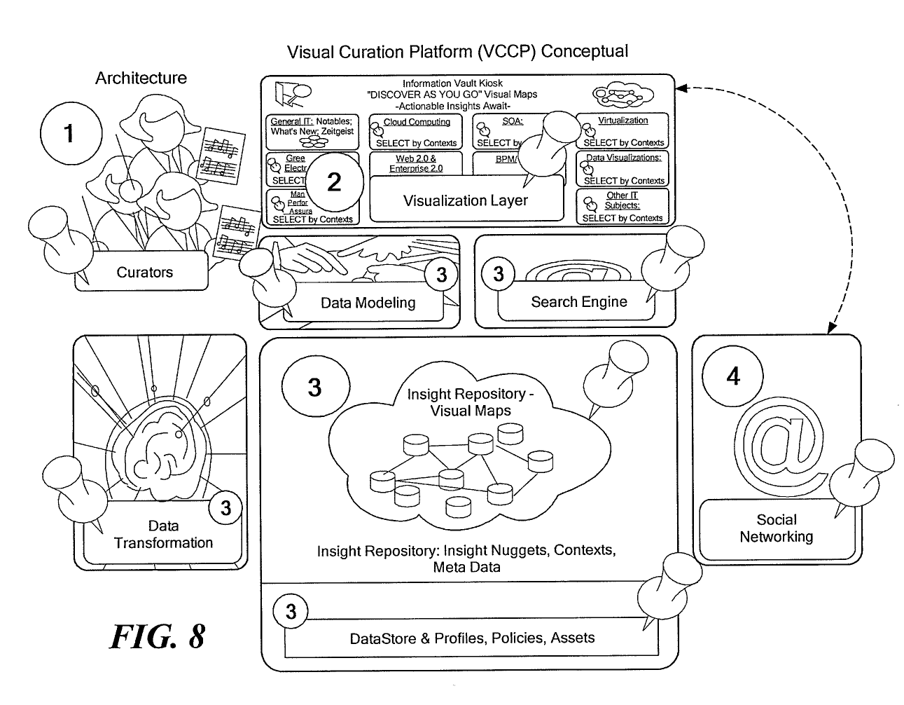

FIG. 8 provides a summary of services and tools for a front end and backend of the visual curation platform in accordance with the present disclosure. Visual map creators may typically be curators who transform data/input in a text format into interactive, zoomable visual maps embedded with fine grained contexts and interconnections. Backend support for a visual map can include data mapping and modeling. Additional user support can be provided for various desired applications, including social networking, search support, selective printing, fluid navigation and dynamic zooming capability, as well as individual customization or personalization. The software services and tools can be used to support “supply-side” as well as “demand-side” operations that can be implemented in the visual map.

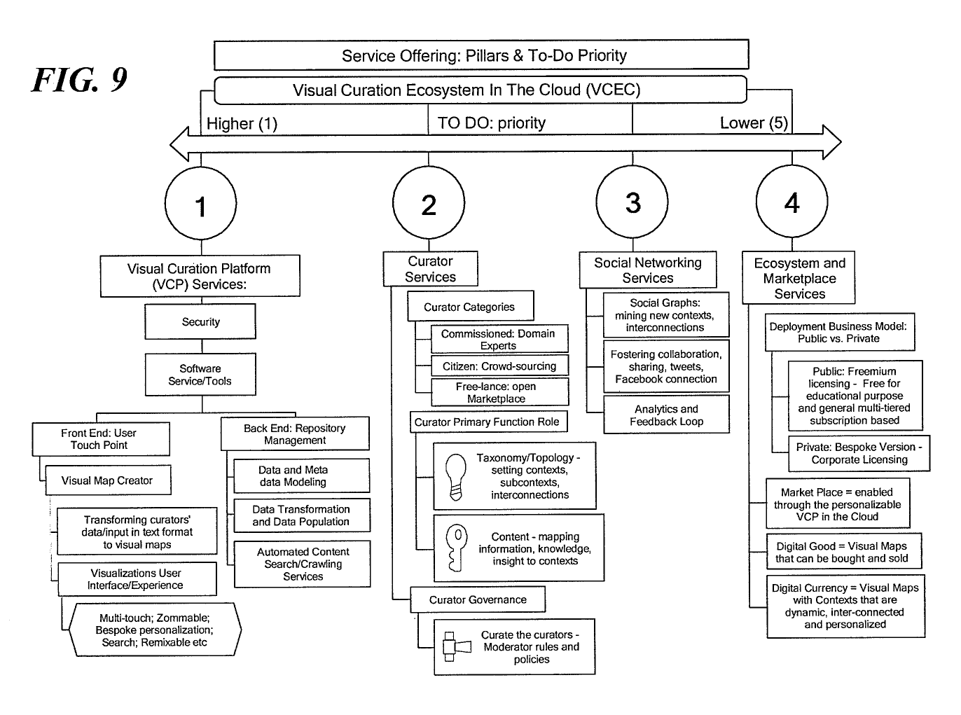

Referring to FIG. 9, a hierarchy of processes to implement a given visual map is illustrated. The processes put in place can be implemented on a priority scale from 1 to 4, higher to lower, as indicated in FIG. 9. The indicated higher priorities include visual curation platform services, which may be implemented within a secure system, and may include visual map creation and data and metadata modeling, as well as repository management. A further priority 2 in the hierarchy is curator services, where roles of curators and their domains are identified and defined. The decisions made by curators can be reviewed and moderated to improve the overall usefulness of a visual map and the overall system. A further priority 3 is related to social networking services, including obtaining feedback and fostering collaboration from various entities and constituencies. Finally, a further priority 4 is the development of a marketplace and marketing tools that can be applied to visual maps.

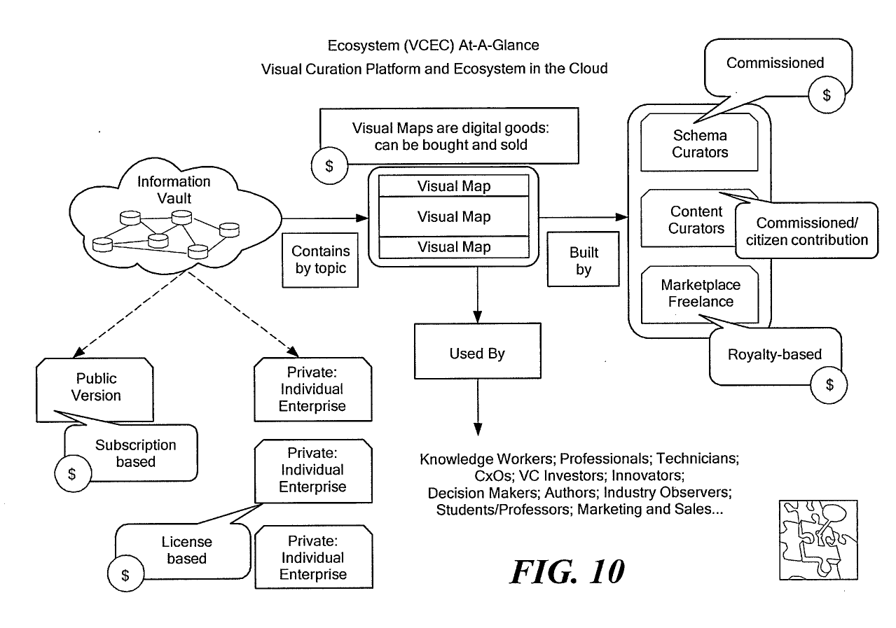

Referring now to FIG. 10, a diagram illustrating certain types of process flows and uses of the visual map in accordance with the present disclosure is illustrated. A repository, or information vault, may include different types or versions of information, which may be separated in accordance with public or private categories. Access to the information in the repository is obtained through visual maps and/or applications, which may be bought and sold among various entities or constituencies for obtaining particular context oriented access to information in the repository or useful results of an application based on such information. The visual maps or applications may be provided on the basis of a public or private version, and may potentially be created by public or private schema curators, content curators and/or merchants.

According to an exemplary embodiment, visual maps and their attendant schema, including visual topology, metadata, tags, metadata relationships, and generally all the components that go into creating and maintaining a visual map, including searches or updating mechanisms, can be generated automatically. For example, a tool or set of tools can be provided that permit searching a given repository or permit use of the results of a search of a given repository as the basis of a visual map for a given subject. The given repository might be any or all of a key word search or search result, a large scale network such as the Internet, data located on a single device, a stand alone or distributed database, and generally any body of information that is susceptible to organization in accordance with the present disclosure.

Automatic generation of a visual map may be implemented based on one or more keywords or a generated index, for example, and content associated therewith. The schema, metadata and metadata relationships can be generated based on the frequency of occurrence of an identified keyword or concept in a body of information. Different contexts can be identified by the frequency of occurrence of other keywords associated with a more frequently occurring keyword. In this way, a visual map for a given subject in a given repository can be generated to have various contexts and concepts annunciated and categorized in a visual presentation. Other known data mining and knowledge base techniques may also be applied to a given repository to permit automatic generation of a visual map. Once a visual map is automatically generated, it can be reviewed and modified by an individual, a curator or groups of individuals or curators. The automatically created visual map can also be provisioned with automated mechanisms to update the contexts and content, which can similarly be reviewed and modified by various constituencies including curators.

Applications provided with a visual map, such as application 450 in visual map 400 (FIG. 4) can be stand alone or context dependent, or can potentially operate according to either or both formats. An independent application can accept input from a number of sources which are not necessarily limited to a visual map or repository, and can operate independently of a visual map or a given context. An application associated with a visual map or context may depend on information related to that visual map or context for input to be able to produce a useful result. In either case, an application can be provided at a given visual node of a visual map to provide the user with a context-oriented application execution feature that can be launched directly from the visual map. An application can be identified with a URL associated with or embedded in a given visual node or context.

With respect to applications that depend on the context or content of a visual map for input, an input data structure can be used to provide the application with desired input. For example, the application may retrieve vectors from a repository to locate links to other contexts, data or applications that can be used as input to the current application. The input data structure can thus accommodate vectors, pointers, tags, metadata and metadata relationship indicia, or interpretations or representations thereof. The access to the context and visual map structure is an important feature of the context-oriented application, since the input data to the application can be curated and modified in accordance with curation activities. Accordingly, such an application can be dynamic in nature, in that it can harness modifications to the context and visual map brought about by curation activities to produce improved and more useful results for a user or a group of users.

A feature of the applications that can be provided in accordance with the present disclosure is a set of rules that are used to determine how or when visual nodes or contexts should be accessed to obtain or present information. For example, rules can be implemented to update a given data structure used by the application, or an output of the application, on a time-oriented or on an event occurrence basis. Other rules can be used to determine whether a visual node or context has changed so that the application can conduct an update to input information in accordance with the modified visual node or context. For example, a curator may add new contexts, visual nodes, links to the same or data, some or all of which can be used to trigger a rule in the application to process and/or incorporate the newly modified elements of the visual map used as input by the application.

The use of rules in the application facilitates maintenance by curators, users, or by machine learning, as discussed above. Accordingly, applications that may be generally applicable to contexts and visual maps can be customized by and/or for a given user or for a given context. Rules may also be provided in the application to seek out other like applications in other linked contexts or in other context-enabled structures such as other visual maps, for example. Rules can be implemented to be triggered based on an event, such as when a linked application, context, visual map or data changes, to cause the modification to be processed and incorporated in the application to produce new updated output information.

Applications can identify URLs at other context nodes, such as by examining vectors associated with such nodes. An application can link to or execute applications in a given visual map or context, which linking or execution can be done conditionally based on such items as metadata or metadata relationships associated with a given context or visual node. Some of the rules in an application can cause the application to be modified itself, such as by adding new rules, modifying existing rules, or deleting rules from the application. These types of activities that dynamically modify the application itself can be considered to fall within the category of machine learning. The application can be downloaded to a client device, such as in the case of an RIA client, to execute on the client device. The application may comply with object oriented conventions, and may be stored in whole or in part in the repository.

According to an exemplary embodiment, an application can receive external inputs, such as may be provided on the basis of personal or individual context information to produce personal integrated results. The personal analytics described above is such an example of an application that can accept external inputs for personal result outputs. The external inputs can be used in conjunction with contextual-oriented data obtained from a given context or visual map to augment the usefulness of the application. For example, the application may accept personal medical analytics to monitor the health of an individual, and compare the data with updated research information that can be curated in a visual map to which the application is linked. Accordingly, the personal analytics of an individual can be used in conjunction with up to date or state of the art knowledge with respect to a given medical or health condition to provide helpful information or actions with respect to a user's health or medical condition.

Applications can interface with other like applications that may also use contextual-oriented information to permit distributed computing implementations. For example, the applications that can be linked in a context-oriented system may have a common application programming interface (API) that permits interaction among the applications. The applications can call each other using the common API, which has an interface structure and function that is known to the other applications. The applications themselves may also store contextual-oriented data in a repository, such as metadata, metadata relationships and other types of data, as discussed above, which may be useable by other applications that can also access the repository. For example, the information stored in the repository can be in the form of XML code or other formats that can be commonly used among applications. In addition, the repository may store definitions for how applications can interact with each other, such as by defining APIs, data structures or libraries, for example, that can be commonly used by contextual-oriented applications. Curators can set such definitions in the repository to permit application interaction.

The applications can significantly enhance the usefulness of the contextual-oriented data provided in a visual map, since that data is curated or otherwise updated on a global or individual basis, for example. In addition, applications that have such a dynamic feature can enhance the usefulness of applications to which they are linked by providing up to date information or expanded knowledge that can be used by other applications to increase the dynamic usefulness of the applications. Internal applications can also be provided for use with visual maps, such as applications that can aggregate usage information to determine patterns or trends with respect to usage of a visual map, for example. The statistical analytics discussed above can be implemented as such an application, for example. Applications that provide security for public or private visual maps, or data ownership may also be used in conjunction with visual maps to provide specified access for contextual-oriented subject matter.

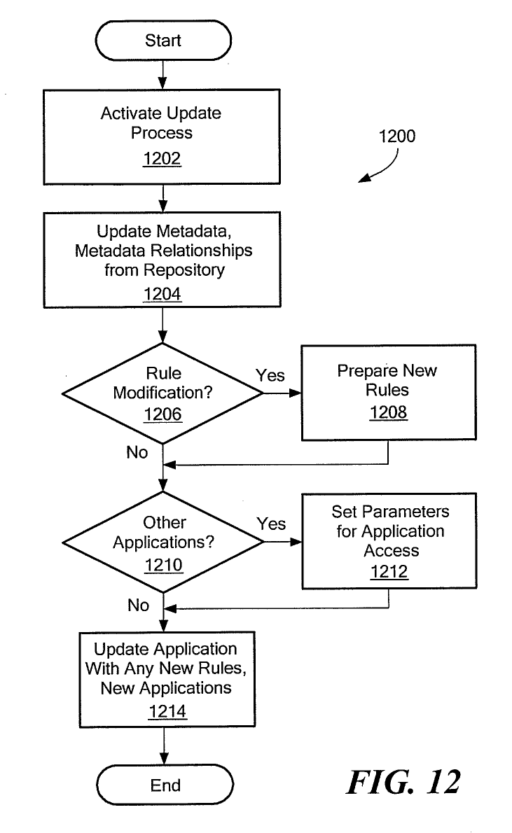

Referring now to FIG. 12, a flowchart 1200 illustrates a process for updating a context-oriented application in accordance with an exemplary embodiment of the present disclosure. The process illustrated in flowchart 1200 can begin with a prompt to activate an update to the application, as depicted in block 1202. Various prompts can be used to activate the process, including events such as updates to visual maps, context, data or other linked applications, as well as timer expirations or calendar events. Upon initiation of the process, the application can access a repository that may store data structures, links, metadata, metadata relationships or other data related to operation of the context-oriented application. The access to the repository, as well as the events used to initiate the process illustrated in flowchart 1200, can be formed on the basis of rules established for the application. Upon inspecting the repository, as illustrated in block 1204, the application can determine if new data or other contextual-oriented modifications have been made to indicate that an update to the application may be warranted.

A decision block 1206 illustrates the determination of whether a rule of the application should be modified based on the inspection of the information in the repository related to the application. If a rule modification is called for, the new rules are prepared, or otherwise updated, as shown with the Yes branch of decision block 1206 being directed to block 1208 of flowchart 1200. The process illustrated in flowchart 1200 may then determine whether other actions may be needed for updates to links or relationships with other context-oriented applications, as is indicated in decision block 1210. For example, certain tags or data structures used by other applications may be updated or modified, indicating that the application executing the process of flowchart 1200 should be updated, or incorporate the changes. If updates based on other context-oriented applications are indicated, the particular parameters can be updated for such application access, as indicated in block 1212 being reached by the Yes branch of decision block 1210. As an example, a new or modified definition for accessing other applications may be established, which may need to be updated in the current application, such as by incorporating or modifying a rule set in the application.

Once the new data and relationships are determined and able to be implemented, the process illustrated in flowchart 1200 updates the application with any new rules or new application links or data, as illustrated in block 1214. The newly updated application can now take advantage of updated rules and links to other contexts, visual nodes, applications or other information that may be available in the repository.

The present disclosure may be applied to a number of practical situations and scenarios to reliably improve information, relevancy and usability. For example, more pertinent information can be provided to researchers or demographics sought by certain advertisers. Businesses, vendors and customers can more easily cooperate and understand the needs and goals of the various constituencies involved in the business relationships. Internal business organizations can benefit from obtaining simplified access to information that may not be readily available across departmental or divisional boundaries. New connections and insight into relevant subject matter can be obtained by bringing to bear multiple different disciplines or perspectives on a given topic, within a given context or sub-context. Potential applications in the field of medicine are numerous, from improving diagnoses to increasing quality of patient care, for example. In general, any application that involves management of information can benefit from the implementation of the visual map, contexts, connections and conceptual relationships provided by the present disclosure. A comparison of some of the advantages of the present disclosure over other known systems is presented in the Appendix Table 1.

The operations herein depicted and/or described herein are purely exemplary and imply no particular order. Further, the operations can be used in any sequence when appropriate and can be partially used. With the above embodiments in mind, it should be understood that they can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared and otherwise manipulated.

Any of the operations depicted and/or described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The disclosed systems and methods can also be embodied as computer readable code on a computer readable medium. The computer readable medium is any data storage device that can store data, which can be thereafter be read by a computer system. Examples of the computer readable medium include hard drives, read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

The foregoing description has been directed to particular embodiments of this disclosure. It will be apparent, however, that other variations and modifications may be made to the described embodiments, with the attainment of some or all of their advantages. The procedures, processes and/or modules described herein may be implemented in hardware, software, embodied as a computer-readable medium having program instructions, firmware, or a combination thereof. For example, the function described herein may be performed by a processor executing program instructions out of a memory or other storage device. Therefore, it is the object of the appended claims to cover all such variations and modifications as come within the true spirit and scope of the disclosure.

APPENDIX

| | | | | | | | Topical |
|---|---|---|---|---|---|---|---|
| | Present | | Google/ | | Info Mgmt/ | “TheBrain”/ | Curated |
| | Disclosure | Wikipedia | Search et al | Facebook | Storage | Mindmaps | WebSites |
| Knowledge/ | Yes: Cloud- | No: online | No: a tool but | Insight: | No | No: a tool | No |
| Insight Curation | based | encyclopedia | not a platform | Incidental | | but not a | |
| Platform | | | | | | platform | |
| Knowledge/ | Yes: | Not a true | No | No | Yes - but | Not a true | Not a true |
| Insight | Cumulative | repository: | | | w/o out-of- | repository: a | repository: |
| Repository | content out | standard Web | | | box content; | visual display | standard Web |
| (persistent) with | of the box; | pages | | | DIY | | pages |
| search; DR/BR; | continuous | | | | | | |
| access/query | updates | | | | | | |
| Curation: out-of- | Yes | No | No | No | No | No | Yes |
| box Top-down | | | | | | | |
| Curation: | Yes | Yes | No | Incidental | No | No | No |
| Bottom-up | | | | | | | |
| Collaboration: | Yes | No | No | Yes | No | No | Typically No |
| Social | | | | | | | |
| Networking | | | | | | | |
| Visual: | Yes: a visual | No: text-based | No: text-based | No: text-based | No | Yes: but | No: text-based |
| Interactive, | map for | | | | | limited | |
| zoom-able | each subject | | | | | | |
| navigation | | | | | | | |
| Context-driven: | Yes: | No | No | No | No | No | No |
| decoupling | foundation | | | | | | |
| context from | | | | | | | |
| content | | | | | | | |
| Context before | Yes: core | No | No | No | No | No | No |
| Content | tenet | | | | | | |
| Personalizable | Yes: | No | No | No | No | No | No |
| Taxonomy | consumer | | | | | | |
| | empowerment | | | | | | |
| Personalizable | Yes: on | No | Involuntary - | Yes | No | Yes | No |
| Content | demand | personalization | automatic | | | | |
| | | but moderators | “filter” bubble | | | | |
| | | can edit | | | | | |
| Personalizable | Yes | No | No | Yes: limited | No | Yes | No |
| Organization | | | | | | | |
| Knowledge: | Yes | No | No | No | No | No | Maybe |
| Correlated by | | | | | | | |
| Curators | | | | | | | |
| Knowledge: | Yes: | No | No | No | No | No | Maybe |
| Interconnected | “connect | | | | | | |
| by Curators | 360” | | | | | | |
| e-Commerce: | Yes | No | No | No | No | No | No |
| buy, sell micro | | | | | | | |
| Insight Nuggets | | | | | | | |
| Precise on-line | Yes | No: non-profit | Imprecise: | Imprecise: | No | No | Imprecise: |
| ad placement | | | placement | placement | | | placement |
| sans massive | | | based on | based on | | | based on |
| historical user | | | keywords and | keywords and | | | keywords and |
| data | | | user profiles | user profiles | | | user profiles |

What is claimed is:

1. A computer implemented platform for managing information in a network, comprising:
a processor communicatively coupled to a memory and operable to access and execute instructions from the memory to:
store schema related data that defines relationships between defined categories of data;
store context related data that identifies each of the defined categories and that associates content related data with each one of the defined categories;
receive a request for information related to a first defined category;
retrieve the context related data for the first defined category;
inspect the schema related data to determine at least a first relationship between the first defined category and a second defined category;
retrieve the context related data for the second defined category; and
provide the retrieved context related data and the schema related data for the first and second defined categories to a network destination indicated by the request.

2. The platform according to claim 1, further comprising:
mode information in the request related to a mode of operation;
the processor being operable to modify the schema related data in accordance with a first mode of operation indicated in the mode information; and
the processor being operable to refrain from modifying the schema related data in accordance with a second mode of operation indicated in the mode information.

3. The platform according to claim 1, further comprising:
first authorization information in the request;
second authorization information associated with the schema related data and the context related data; and
the processor being operable to compare the first and the second authorization information to determine whether the request for the first defined category is authorized.

4. The platform according to claim 1, further comprising:
a statistics repository communicatively coupled to the processor and including statistical data corresponding to requests received for the first defined category; and
the processor being operable to update the statistical data in response to requests.

5. The platform according to claim 1, further comprising:
an ad repository communicatively coupled to the processor and including ad content and ad placement criteria; and
the processor being operable identify context related data in accordance with the ad placement criteria and provide the ad content with the identified context related data to the network destination.

6. The platform according to claim 1, further comprising:
an application associated with a first context related data; and
the processor being operable identify the application in accordance with the request and provide the application to the network destination.

7. The platform according to claim 6, wherein the application further comprises an interface that permits access to the application by other applications with the interface.

8. The platform according to claim 6, wherein the application further comprises a link to a first context related data such that the application can access the content related data associated with the first context related data.

9. A method for managing information in a network that is implemented on a computer that includes a processor and a memory that stores instructions that are executable by the processor, the method comprising:
storing schema related data that defines relationships between defined categories of data;
storing context related data that identifies each of the defined categories and that associates content related data with each one of the defined categories;
receiving a request for information related to a first defined category;
retrieving the context related data for the first defined category;
inspecting the schema related data to determine at least a first relationship between the first defined category and a second defined category;
retrieving the context related data for the second defined category; and
providing the retrieved context related data and the schema related data for the first and second defined categories to a network destination indicated by the request.

10. The method according to claim 9, further comprising:
receiving mode information in the request related to a mode of operation; and
determining, in accordance with the mode information, whether the schema related data should be modified in accordance with the request.

11. The method according to claim 9, further comprising:
receiving first authorization information in the request;
obtaining second authorization information associated with the schema related data and the context related data; and
comparing the first and the second authorization information to determine whether the request for the information related to the first defined category is authorized.

12. The method according to claim 9, further comprising collecting statistical data corresponding to requests received for the information related to the first defined category.

13. The method according to claim 9, further comprising:
providing an ad repository communicatively coupled to the processor and including ad content and ad placement criteria; and
identifying context related data in accordance with the ad placement criteria and providing the ad content with the identified context related data to the network destination.

14. The method according to claim 9, further comprising:
associating an application with a first context related data; and
identifying the application in accordance with the request and providing the application to the network destination.

15. The method according to claim 14, further comprising providing an interface in the application that permits access to the application by other applications with the interface.

16. The method according to claim 14, further comprising accessing the content related data associated with the first context related data using the application.

17. A communication device communicatively coupled to a network, comprising:
a processor that is communicatively coupled to a memory and operable to access and execute instructions from the memory to:
provide a request for information related to a first defined category;
receive schema related data that defines relationships between the first defined category and other defined categories of data;
receive context related data that identifies the first and other defined categories; and
provide a display of a visual map of the context related data that is organized in accordance with the schema related data.

18. The communication device according to claim 17, wherein the processor is further operable to receive an application that can access the context related data as input.

19. A method for organizing information that is implemented on a communication device that includes a processor and a memory that stores instructions that are executable by the processor, the method comprising:
receiving schema related data that defines relationships between defined categories of data;
receiving context related data that identifies each of the defined categories and that associates content related data with each one of the defined categories;
inspecting the schema related data to determine at least a first relationship between a first and a second defined category;
identifying the context related data that identifies each of the first and the second defined categories; and
displaying a visual map of the context related data for the first and the second defined categories, the visual map including nodes representing the context related data that are organized in accordance with the schema related data.

20. The method according to claim 19, further comprising receiving an application that can access the context related data as input.
